(19) United States
(12) Patent Application Publication
(10) Pub. No.: US 2006/0023573 A1
(43) Pub. Date: Feb. 2, 2006

(54) Method and system for enhanced optical medium reads

(76) Inventors: Manuel Rivera JR., Pflugerville, TX (US); David M. Pereira, Austin, TX (US)

Correspondence Address: HAMILTON & TERRILE, LLP, P.O. BOX 203518, AUSTIN, TX, 78720, US

(21) Appl. No.: 10/901,543

(22) Filed: Jul. 29, 2004

(51) Int. Cl. G11B 19/02

(52) U.S. Cl. 369/30.1; 369/47.1

(57) ABSTRACT

An optical drive reads information from an optical medium by measuring the reflectivity of the optical medium to determine the type of optical medium, setting read parameters associated with the determined type and attempting to read identification information from the optical medium to verify the optical medium type. If the identification information verifies the type of optical medium as determined by the measured reflectivity, the optical drive reads information with the read parameters. If the identification information is not readable or fails to verify the measured optical medium type, an alternative optical medium type read parameters are used to read the identification information. If the alternative optical medium type matches the identification information optical medium type, read parameters associated with the alternative optical medium type are used to read information from the optical medium and the user is provided a warning that the optical medium has substandard quality.

### BACKGROUND OF THE INVENTION

1. Field of the Invention

The present invention relates in general to the field of reading information from optical media, and more particularly to a method and system for enhanced optical medium reads by comparing reflectivity measurements with expected reflectivity.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated.

The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

An increasingly popular media for storing information is writable and re-writable optical media, such as CD and DVD disks. Greater consumer demand for writable optical media has led to a greater number of manufacturers of writable optical media with a wider diversity of quality standards based on manufacturing dye formulations and process parameters. Optical drives store information on these optical media by illuminating an optical medium disk with a focused laser beam that alters the reflective properties of the medium. The information is read from the optical medium by illumination of the medium with a lower powered laser and by measuring the reflectivity of the optical medium. When writing information to an optical medium, optical drives typically identify an inserted disk by type and manufacturer from an identification code embedded on the disk by the manufacturer and then apply a write strategy associated with the identified optical medium to write the information onto the disk. For instance, CD-R and CD-RW media store identification information in the ATIP, a pre-molded recording groove with timing and other information, and DVD-R and DVD-RW media store identification information in a lead-in area. In contrast, when reading information from an optical medium, optical drives typically measure the reflectivity level of an optical medium to determine its type, such as writable versus re-writable, and compare the measured reflectivity with the acceptable reflectivity ranges required by the standards for each type of optical medium. Based upon the measured reflectivity, the optical drive sets read parameters for the type of optical medium to read information.

One difficulty faced by optical drive manufacturers is that the reflectivity measured from some lower quality optical media are outside of the bounds of allowed reflectivity. In such situations, the measured reflectivity may result in a misidentification of the type of optical media. For instance, a CD-R optical medium with reflectivity that falls out of the bounds of allowed reflectivity under the CD-R standard may be misidentified by an optical drive as a CD-RW optical medium, however, information stored on the CD-R will not be readable by the optical drive with the CD-RW read parameters. Improper read parameters lead to poor user experiences since information stored on the optical medium appears unusable or defective. Where reflectivity is borderline between that expected of two different types of optical media, an optical medium may appear both useable and intermittently unusable. Although users desire to take advantage of the larger storage available on optical media, the perceived unreliability of optical media results in users avoiding the storage of important information in favor of more expensive options having a perceived greater reliability, such as magnetic media. As the number of manufacturers of optical media increases, greater variations in quality of optical media manufactured by inexperienced suppliers seeking to reduce manufacture costs will increase the problem of perceived unreliability of optical media.

### SUMMARY OF THE INVENTION

Therefore a need has arisen for a method and system which detects undesired variations from expected optical media reflectivity for an optical medium in use at an optical drive.

A further need exists for a method and system which provides a warning to an information handling system user before writing information to optical media having undesired variations from expected optical media reflectivity for an optical medium in use at an optical drive.

In accordance with the present invention, a method and system are provided which substantially reduce the disadvantages and problems associated with previous methods and systems for reading information from optical media. An optical drive reads information from an optical medium by comparing the expected reflectivity of the optical medium with an observed reflectivity to set the optical drive read parameters. Undesired variations in measured reflectivity from expected reflectivity results in warnings that the optical medium has substandard or low quality.

More specifically, a read module in the optical drive measures the reflectivity of an optical medium to determine the type of optical medium, such as writable or re-writable, and sets read parameters for the type of medium associated with the measured reflectivity. A verification module applies the read parameters to attempt a read of identification information from the inserted optical medium and verifies the optical medium type if the identification information indicates a match with the measured reflectivity type. If the measured reflectivity optical medium type fails to match the identification information type or the attempt to read the identification information fails, the verification module attempts a read of the identification information with alternative optical medium type read parameters. The verification module takes corrective action where measured reflectivity fails to match identification information, such as by selecting appropriate read parameters having an optical media type match or the read parameters that successfully read information. Other examples of corrective action includes presenting a warning to the user interface that the optical medium has low or substandard quality, or restricting writes to the optical medium.

The present invention provides a number of important technical advantages. One example of an important technical advantage is that an optical drive automatically verifies optical medium type by comparing measured reflectivity with embedded identification information. Another example of an important technical advantage of the present invention is that detection of undesired variations allows a quality warning to a user that explains the failure of the optical drive to read an optical medium. Effective warnings of low quality media prevent unnecessary user inquiries about optical drive failures and reduce the risk that important information will be lost if written to a substandard or low quality optical medium.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of an information handling system having optical medium type verification of optical media inserted in an optical drive; and

FIG. 2 depicts a flow diagram of a process for verification of optical medium type at an optical drive.

### DETAILED DESCRIPTION

An optical drive reads information from an optical medium type, such as a writable optical medium type or a re-writable optical medium type, by measuring the reflectivity of an inserted optical medium to determine the type and verifying the type with a read of identification information from the optical medium to compare the measured reflectivity against expected reflectivity. In the event that measured reflectivity falls outside of an expected range, the optical drive takes corrective action, such as selecting altered read parameters to read information from the optical medium or providing a warning to an associated information handling system that the optical medium is substandard. For purposes of this application, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

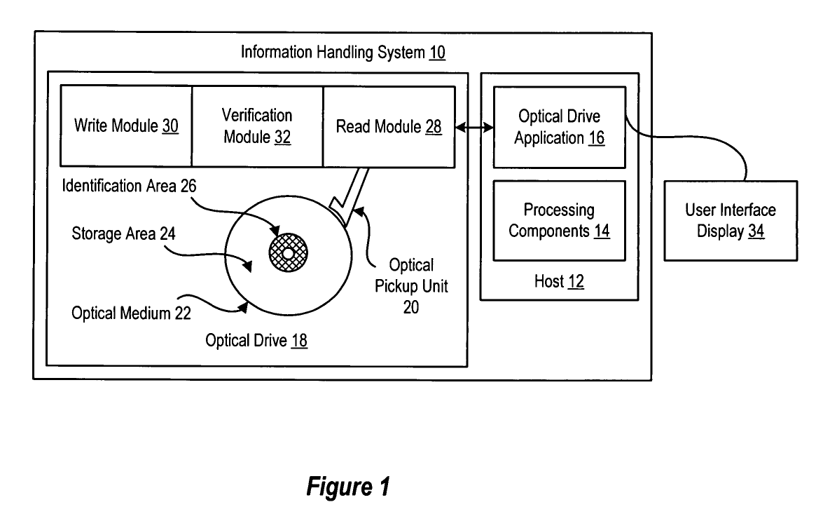

Referring now to FIG. 1, a block diagram depicts an information handling system 10 that verifies optical medium quality to select read parameters for reading information from the optical medium. Information handling system 10 includes a host 12 having processing components 14 and an optical drive application 16 to interface with and support the operation of an optical drive 18. Optical drive 18 includes an optical pickup unit 20 having a laser operable to illuminate an optical medium 22 to read information from and write information to optical medium 22, such as a CD-R, CD-RW, DVD-R, DVD+RW or DVD-RAM disk. For instance, host 12 is managed by an operating system, such as WINDOWS, that includes optical drive application 16 as a driver that manages reads of information from and writes information to a storage area 24 of optical medium 22 by running on processing components 14, such as the CPU. Optical medium 22 has identification information stored by its manufacturer, typically embedded in a non-user accessible information area 26, such as in the ATIP of a CD-R or CD-RW disc or the lead-in area of a DVD-R, or DVD+RW disc. The optical medium identification information uniquely identifies the optical medium by manufacturer, formulation and type, and is typically used to select a write strategy for writing information to optical medium 22. For instance, the write strategy defines the pulse power, shape, width and other parameters used by the laser in optical pickup unit 20 to write information to optical medium 22.

When an optical medium 22 is inserted in optical drive 18, a read module 28 identifies the type of optical medium 22 by illuminating optical medium 22 with the laser of optical pickup unit 20 and measuring the reflectivity from optical medium 22. Read module 28 compares the observed reflectivity of the laser reflection from optical medium 22 against predetermined reflectivity ranges to determine if optical medium 22 is read only, writable or re-writable. For instance, the comparison of measured reflectivity is made against reflectivity ranges defined by standards for each type of optical medium that define the allowed range of reflectivity of an optical medium of each type. Once the measured reflectivity is determined for optical medium 22, read module 28 selects read parameters associated with the type of optical medium having the reflectivity range in which the measured reflectivity falls. Read module 28 applies the read parameters to perform functions selected by optical drive application 16, such as reading information from storage area 24. In the event that a write to optical medium 22 is requested, read module 28 reads the embedded identification code or other identification indicia from identification area 26 and provides the identification information to a write module 30 which obtains an appropriate write strategy for writing information to optical medium 22, such as by looking up the identification code in an optical drive write strategy table stored in optical drive non-volatile memory.

A verification module 32 interfaces with read module 28 and write module 30 to verify the type and quality of an inserted optical medium 22. Verification module 32 compares the measured reflectivity optical medium type determination with the identification information embedded in optical medium 22 to verify that the measured reflectivity type information matches the type indicated by the identification information. For instance, if the measured reflectivity of optical medium 22 falls in a range associated with a CD-RW and the identification information read from optical medium 22 indicates that optical medium 22 is a CD-RW, then the identification information type matches the measured reflectivity type. If the identification information indicates a non-matching optical medium type, such as a CD-R, then the reflectivity of optical medium 22 falls outside of the standard range allowed for CD-R optical media and is determined to be substandard. Similarly, if read parameters set in response to measured reflectivity, such as read parameters associated with a CD-R optical medium type, result in a failed attempt to read identification information, verification module 32 directs read module 28 to reattempt a read of identification information with alternative read parameters, such as read parameters associated with a CD-RW optical medium type. A successful read likely indicates a substandard optical medium but allows a determination of the optical medium type from the identification information so that information may be retrieved from the optical medium with altered read parameters.

Verification module 32 may take a number of corrective actions when a substandard optical medium is determined. For instance, in one embodiment, verification module 32 selects read parameters associated with the optical medium type indicated by the identification information instead of that indicated by the measured reflectivity. In another embodiment, verification module 32 provides a warning at a user interface display 34 that the optical medium is substandard or has a lower quality that may present readability difficulties. In another embodiment, a warning issues before write operations are allowed to the optical medium suggesting that the user not store important information since the optical medium has a low quality. In yet another embodiment, the quality of inserted optical media is tracked by comparing measured reflectivity against designed reflectivity so that the user is able to gauge optical media quality in selecting optical media for purchase and for types of use, such as restricting long-term storage to higher quality optical media.

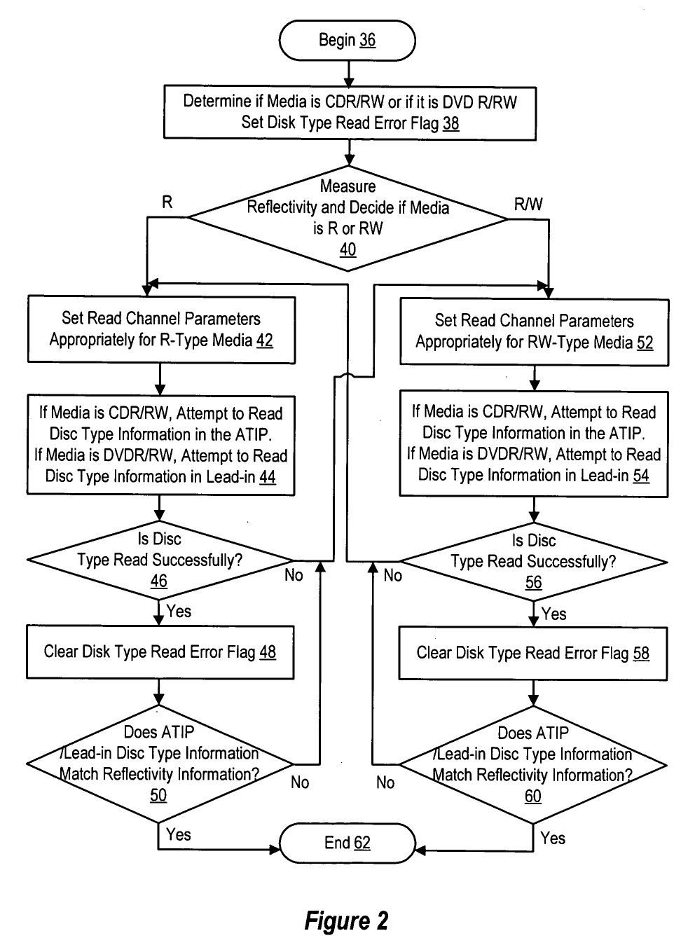

Referring now to FIG. 2, a flow diagram depicts a process for verification of optical media type based on a comparison of measured reflectivity with identification information. The process begins at step 36 with initial insertion of an optical medium into an optical drive. At step 38, the optical drive sets an error flag and determines whether the optical medium is a CD or a DVD. At step 40, a reflectivity measurement is performed on the optical medium to determine whether the optical medium falls in the writable (R) type or the re-writable type (RW). If the measured reflectivity indicates a writable optical medium, the process continues to step 42 to set the read channel parameters for R-type media. At step 44, a read of Disc Type information is attempted from the ATIP for CD media and from the Lead-in area for DVD media. At step 46, a determination is made whether the Disc Type information was successfully read and, if yes, at step 48 the error flag is cleared and at step 50 a determination is made whether the Disc Type information matches the type determined by the measured reflectivity. If the determination at step 50 is yes, the verification process ends. If the determination at step 46 or step 50 is no, the process continues to step 52.

If an inserted optical medium has a measured reflectivity of re-writable (RW) or if the optical medium fails to validate as a writable optical medium, at step 52 the read channel parameters are set for RW-type optical media. At step 54, a read of Disc Type information is attempted from the ATIP for CD media and from the Lead-in area for DVD media. At step 56, a determination is made whether the Disc Type information was successfully read and, if yes, at step 58 the error flag is cleared and at step 60 a determination is made whether the Disc Type information matches the type determined by the measured reflectivity. If the determination at step 60 is yes, the verification process ends. If the determination at step 56 or step 60 is no, the process continues to step 42 as described above. In various embodiments, retry counters and loops are included to retry the reflectivity measurements and identification reads for a predetermined number of iterations. Each iteration may be performed at reduced speeds to provide greater readability. Failure to verify optical medium type within the predetermined iterations results in rejection of the optical medium as unusable.

Although the present invention has been described in detail, it should be understood that various changes, substitutions and alterations can be made hereto without departing from the spirit and scope of the invention as defined by the appended claims. For instance, other measurements of optical medium quality may be performed and compared with expected results to aid user management of information storage on optical media, such as by rating the reliability of an inserted optical medium based on the observed results or even a test write.

What is claimed is:

1. An information handling system comprising:
a host having plural components operable to run applications;
an optical drive application operable to run on the host to communicate information with an optical drive;
an optical drive interfaced with the host and operable to read information from first and second types of optical media, the first type of optical media having a first reflectivity range, the second type of optical media having a second reflectivity range;
a read module associated with the optical drive, the read module operable to measure the reflectivity from an optical medium to determine the first optical medium type and to select first set of read parameters associated with the first optical medium type for reading information from the optical medium; and
a verification module interfaced with the read module and operable to read identification information from the optical medium to verify the optical medium type associated with the identification information matches the first optical medium type determined from the measured reflectivity.

2. The information handling system of claim 1 wherein the verification module is further operable to select second set of read parameters associated with the second optical medium type if the identification information fails to match the first optical medium type.

3. The information handling system of claim 2 wherein the verification module is further operable to verify a successful read of information from the optical medium with the second set of read parameters.

4. The information handling system of claim 2 wherein the verification module is further operable to determine that the identification information is unreadable with the first set of read parameters and to attempt a read of the identification information with the second set of read parameters.

5. The information handling system of claim 2 wherein the verification module is further operable to attempt a read with the second set of read parameters, to determine the attempted read failed and to change to the first set of read parameters.

6. The information handling system of claim 2 wherein the verification module is further operable to communicate to the optical drive application the failure to match the optical medium type determined from the measured reflectivity and the optical medium type determined from the identification information, and wherein the optical drive application is further operable to present a warning at the information handling system that the optical medium has substandard quality.

7. The information handling system of claim 1 further comprising a write module associated with the optical disc drive and operable to write information communicated from the optical drive application to the optical medium, the write module interfaced with the verification module and further operable to prohibit writes to the optical medium until a warning is presented at the information handling system that the optical medium has substandard quality if the optical medium type determined from the measured reflectivity and the optical medium type determined from the identification information fail to match.

8. The information handling system of claim 1 wherein the first and second optical media types comprise CD-R and CD-RW optical media.

9. The information handling system of claim 1 wherein the first and second optical media types comprise DVD-R and DVD−RW.

10. A method for setting optical drive read parameters to read information from an optical medium, the method comprising:
measuring the reflectivity of the optical medium with the optical drive;
comparing the measured reflectivity with plural reflectivity ranges, each reflectivity range associated with an optical medium type;
determining that the optical medium is of a first type associated with one of the reflectivity ranges;
reading optical medium identification information from the optical medium with the optical drive;
determining the optical medium type associated with the optical medium identification information; and
setting read parameters for the optical drive to read information from the optical medium if the first optical medium type matches the type determined from the optical medium identification information, the read parameters associated with the first optical medium type.

11. The method of claim 10 further comprising:
determining that the first optical medium type fails to match the type determined from the optical medium identification information; and
attempting to read from the optical medium with read parameters associated with a second optical medium type.

12. The method of claim 11 wherein determining the first optical medium type fails to match further comprises:
determining that the reading optical medium identification information failed; and
attempting to read the identification information with the read parameters of the second optical medium type.

13. The method of claim 12 further comprising:
determining that the attempting to read optical medium identification information with the read parameters of the second optical medium type failed; and
rejecting the optical medium.

14. The method of claim 11 further comprising:
determining as successful a read of information with the second read parameters; and
setting the read parameters of the second optical medium type to read information from the optical medium.

15. The method of claim 14 further comprising:
presenting a warning that the optical medium is substandard.

16. The method of claim 15 further comprising:
detecting selection of a write operation to write information with the optical drive to the optical medium; and
requiring acknowledgement of the warning before allowing the write operation.

17. The method of claim 10 wherein the optical medium types comprise a writable optical medium type and a rewritable optical medium type.

18. An optical drive for writing information to an optical medium having a reflectivity and identification information, the optical drive comprising:
a pickup unit having a laser aligned to illuminate the optical medium;
a read module interfaced with the pickup unit, the read module operable to command illumination of the optical medium to measure the reflectivity of the optical medium and to determine a measured optical medium type by comparing the measured reflectivity with plural predetermined reflectivity ranges, each reflectivity range having an associated optical medium type, each optical medium type having read parameters; and
a verification module interfaced with the pickup unit and operable to attempt to read the identification information from the optical medium by applying the read parameters associated with the measured optical medium type, the verification module further operable to verify the measured optical medium type if a read of the identification information matches the measured optical medium type.

19. The optical drive of claim 18 wherein the optical medium types comprise a writable optical medium type and a re-writable optical medium type.

20. The optical drive of claim 18 wherein the verification module is further operable to determine that an attempt to read the identification information with the measured optical medium type failed and to apply read parameters of an alternative optical medium type to read the identification information.
